(19) United States
(12) Patent Application Publication
(10) Pub. No.: US 2007/0012317 A1
(43) Pub. Date: Jan. 18, 2007

(54) Medical device tube

(76) Inventors: Robert W. Flagler, Pleasanton, CA (US); Ralph Thomas, Livermore, CA (US); Douglas A. Clement, Livermore, CA (US); Carl Kling, San Ramon, CA (US)

Correspondence Address: Michael G. Fletcher;FLETCHER YODER, P.O. Box 692289, Houston, TX, 77269-2289, US

(21) Appl. No.: 11/177,925

(22) Filed: Jul. 8, 2005

(51) Int. Cl. A62B 9/06

(52) U.S. Cl. 128/207.14

(57) ABSTRACT

A medical device tube comprising a cannula having a formed end and a connector that tightly holds the formed end of the cannula between first and second portions of the connector.

### BACKGROUND OF THE INVENTION

1. Field of the Invention

The present disclosure, according to one embodiment, relates to medical device tubes, e.g., tracheostomy tubes, used in medical applications and, more particularly, to attaching together a cannula and connector of the medical device tube.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

A medical device tube, such as a tracheostomy tube, may be comprised of an outer cannula (slender tube that may be inserted into a body cavity) attached to a head base connector. The tracheostomy tube may be generally “L” shaped and the head base connector may be attached to a swivel neck plate/flange. Because the tracheostomy tube provides an artificial airway for access to the patient's airway for airway management, the tracheostomy tube may be introduced into a tracheotomy incision in the patient's neck that provides access to the trachea. The tracheostomy tube may be secured by means of the swivel neck plate/flange that may be connected to a tracheostomy tube holder or neck strap, thus securing this artificial airway for spontaneous or mechanical ventilation of the patient.

The head base connector and outer cannula are adapted for insertion of a disposable inner cannula. The inner cannula may be inserted into the head base connector and outer cannula after the tracheostomy tube has been placed into the patient's trachea.

This inner cannula typically includes a connector for quick removal of the inner cannula from the outer cannula, e.g., the inner cannula connector removably attaches to the head base connector, so that the inner cannula may be removed quickly if an obstruction, e.g., plug of mucus, sputum, etc., is formed. A mechanical ventilator hose may be coupled to the inner cannula connector for assisting the patient in breathing.

### SUMMARY

Certain aspects commensurate in scope with the originally claimed invention are set fort below. It should be understood that these aspects are presented merely to provide the reader with a brief summary of certain forms of the invention might take and that these aspects are not intended to limit the scope of the invention. Indeed, the invention may encompass a variety of aspects that may not be set forth below.

There is provided a medical device tube that includes: a cannula having a formed end; and a connector comprised of a first portion and a second portion, wherein the cannula and the connector are coupled together by the formed end of the cannula being held between the first and second portions of the connector.

There is also provided a tracheostomy air passage system that includes: a tracheostomy tube comprising, a cannula having a formed end; a connector comprising a first portion and a second portion, wherein the formed end of the cannula is held between the first and second portions of the connector; a ventilator hose coupled to the connector; and a ventilator coupled to the ventilator hose.

### BRIEF DESCRIPTION OF THE DRAWINGS

A more complete understanding of the present disclosure may be acquired by referring to the following description taken in conjunction with the accompanying drawings wherein:

FIG. 1 is a schematic diagram of a patient ventilation system, according to a specific example embodiment of the present disclosure;

FIG. 2 is a schematic cutaway view diagram of a medical device tube having a formed end in a head base connector, according to a specific example embodiment of the present disclosure;

FIG. 3 is a schematic exploded view diagram of the medical device tube having a formed end, first and second portions of the head base connector, and an inner cannula inserted into the head base connector and outer cannula, according to a specific example embodiment of the present disclosure;

FIGS. 4A-4G are schematic cross-sectional diagrams of various medical device tubes comprising outer cannulas having formed ends held in head base connectors having various inside face configurations, according to specific example embodiments of the present disclosure;

FIG. 5 is a schematic cutaway view diagram of a medical device tube having a formed end that may be fillet to lay open two or more flat portions that may be captured by the first and/or second portions of the head base connector, according to a specific example embodiment of the present disclosure;

FIG. 6 is a schematic cutaway view diagram of a medical device tube having a formed end that may be chamfered to substantially match a chamfer of the first and/or second portions of the head base connector, according to a specific example embodiment of the present disclosure;

FIG. 7 is a schematic cutaway view diagram of a medical device tube having a formed end that may be a circumferential bead that may be substantially captured in a corresponding pocket in or on the first and/or second portions of the head base connector, according to a specific example embodiment of the present disclosure;

FIG. 8 is a schematic cutaway view diagram of a medical device tube having a formed end that may have circumferential features adapted to substantially match with corresponding retaining features in or on the first and/or second portions of the head base connector, according to a specific example embodiment of the present disclosure; and

FIG. 9 is a schematic exploded view diagram of a medical device tube having a separately formed end adapted for attachment to a cannula, according to a specific example embodiment of the present disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Strengthening the attachment of a cannula to a head base connector is important. Ease in manufacture and reliability of attachment between the cannula and head base connector may also be important. Maintaining a precise inner diameter of an outer cannula for ease of insertion and proper sealing of an inner cannula may also be desirable.

As discussed in detail below, according to a specific example embodiment of this disclosure, a tracheostomy tube has a formed end, e.g., flare-shaped or flute-shaped portion, located at a proximal end (hereinafter “formed end”) of an outer cannula. The formed end of the outer cannula may be placed between first and second portions of a head base connector. The first portion (e.g., top portion) of the head base connector may be similar in shape to the second portion (e.g., bottom portion) of the head base connector. The first and second portions may clamp the formed end when placed together. The first and second portions of the head base connector may be held together, e.g., by adhesive, bonding, welding, etc. Welding together of the first and second portions of the head base connector may be, for example but not limited to, ultrasonic, radio frequency, laser, hot plate, spin, etc. The first and second portions of the head base connector may also be adapted for snapping together, screwing together, clamping together, etc.

The formed end of the outer cannula may also comprise: 1) filleting the outer cannula tube end to lay open two or more flats that may be captured by the first and second portions of the head base connector, 2) heat forming a circumferential bead that may be captured in a corresponding pocket in the first and second portions of the head base connector. This circumferential bead may provide a thick (strong) transition from the formed end to the cylindrical tube of the outer cannula, 3) in place of a formed end cannula tube radius, use a chamfer that substantially matches a chamfer on the first and second portions of the head base connector, e.g., chamfer in a thicker portion of the wall of the outer cannula toward its end. And/or 4) a mating component that may be attached to the end of the outer cannula to fit/lock with the first and/or second portions of the head base connector.

In addition, the first and/or second portions of the head base connector may have ridges, e.g., circumferential rings, on the inner faces thereof that may be in contact with the formed end of the outer cannula, and capture, e.g., clamp, the formed end between the inner faces of the first and second portions of the head base connector. These circumferential rings may comprise ridges and valleys that may be paired or otherwise aligned so as to promote portions of the formed end being received within at least one valley. The rings may be continuous and/or non-continuous, e.g., broken or dashed. The circumferential rings clamping the formed end may also be used for maintaining an appropriate inner diameter of the outer cannula.

The formed end may be captured between the inner faces of the first and second portions of the head base connector by attaching the formed end to the inner face(s) of the first and/or second portions of the head base connector by using adhesive, bonding, welding, etc. This provides for a far superior connection, and/or reliable continuous connection between the outer cannula and the head base connector then does a simple lap weld, butt joint (weld) or a mere adhesive connection. A portion of the outer surface of the outer cannula, e.g., a portion of the formed end may have adhesive holding it proximate to an inner face of the head base connector. The adhesive may be applied to the outer surface portion wherein a line normal to the outer surface portion is not perpendicular to the central axis of the outer cannula proximate the surface portion, e.g., an acute angle may be formed or it may be substantially parallel.

Within the wall of the outer cannula, including the formed end thereof, there may be a small hollow area, e.g., lumen, that may be used to pass air for inflating a flexible collar located over an outer portion of this cannula. The flexible collar may be inflated so as provide a seal in the patient's airway to air from positive pressure ventilation, and may also stabilize the outer cannula in the trachea of the patient. More than one lumen may be in the wall of the outer cannula and the additional lumens therein may be used for various other purposes.

The inside of the formed end of the outer cannula may be configured for insertion of an inner cannula. The formed end of the outer cannula may be arranged between the first and second portions of the head base connector so as to maintain a uniform inside diameter of the outer cannula for precise and uniform insertion of the inner cannula into the outer cannula. The formed end of the outer cannula may be tapered to provide a natural lead in for the ease of insertion of the inner cannula therein.

An inner ridge or ring of the head base connector may aid in aligning a central axis of the outer cannula with the head base connector. The head base connector may be used, with or without an inner ridge or ring, as a port for insertion of the inner cannula.

Testing for separation between the head base connector and the outer cannula has been made on various combinations of locking mechanisms between the head base connector and the outer cannula. A strain rate of 2 inches per minute was used. Testing conditions where at both room and body temperatures and humidity levels. A plurality of sizes of tracheostomy tubes were used in conducting the following separation tests.

Pull forces were determined using 1) a completed assembly and adhesive of the connector with the formed end of the outer cannula (adhesive and clamping compression of the formed end between the connector portions), 2) the formed end attached to a portion of the head base connector with adhesive only, 3) a complete assembly without adhesive, only clamping compression of the formed end between the head base connector portions, and 4) the formed end in frictional cooperation with only the lower portion of the head base connector.

A separation force was observed such that the failure mode was tube wall failure for the complete assembly and adhesive on the connector portion and formed end as described in 1) above, and the formed end attached to a portion of the head base connector with adhesive only as described in 2) above. A substantial separation force was necessary for bond separation between the formed end and head base connector portions as described in 3) above. The separation force was the lowest where the failure mode was bond separation between the formed end and head base connector portion as described in 4) above.

The proximal end of the outer cannula may be formed by various methods, e.g., heating of the proximal end material. The formed proximal end when pulled toward a smaller diameter opening in a portion of the head base connector may create a locking mechanism that effectively captures the outer cannula in the head base connector and substantially aides in preventing pull out of the outer cannula from the head base connector.

An ultrasonic shear weld around the perimeter of the head base connector may be used to couple together the first and second portions thereof. The head base connector portion proximate to the patient may also be referred to herein as the “bottom portion” or “bottom component” of the head base connector, and the head base connector portion distal from the patient may also be referred to herein as the “top portion” or “top component” of the head base connector. The top and/or bottom portion(s) may have at least one groove adapted for engaging (e.g., gripping) the formed end of the outer cannula. The bottom and/or top portion(s) of the head base connector may provide a compression force (e.g., result of the ultrasonic shear weld geometry) to the formed end into the at least one groove of the top and/or bottom portion(s).

For example, the ultrasonic shear weld may start by welding plastic material of the top and bottom portions together for about approximately 0.025 inches. The shear weld continues to compress, forming the clamping force. The ultrasonic shear welding and compression of the top and bottom portions together may continue, e.g., for about another 0.015 inches. The top and/or bottom portion(s) may “bite” (e.g., with barbs, pins, bumps, etc.) into the formed end of the outer cannula and may be held with the ultrasonic shear weld. An adhesive, e.g., medical grade cyanoacrylate 4161, commercial trade name—LOCTITE® (a registered trademark of the Henkel Corporation, 2200 Renaissance Boulevard, The Triad, Suite 200, 200 Gulph Mills, Pa. 19406), may be used to further secure the formed end of the outer cannula to the bottom portion (component) of the head base connector.

Referring now to the drawings, the details of specific example embodiments are schematically illustrated. Like elements in the drawings will be represented by like numbers, and similar elements will be represented by like numbers with a different lower case letter suffix.

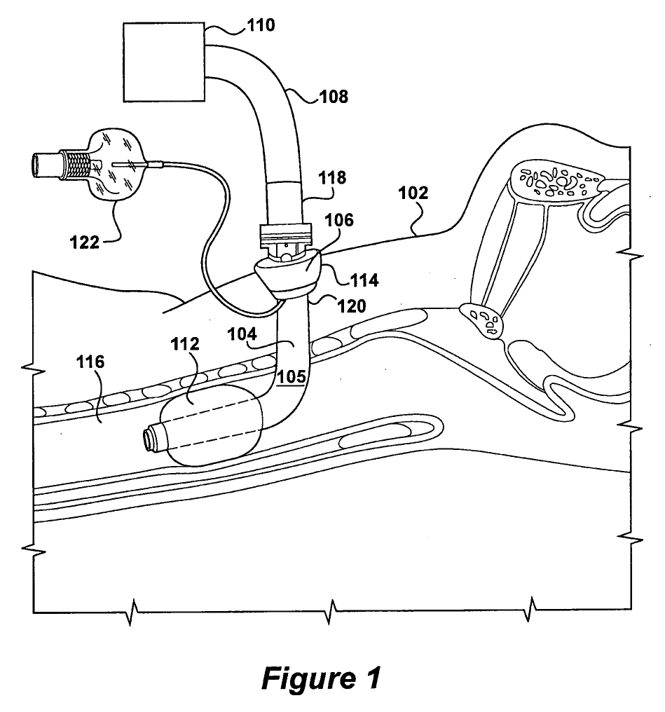

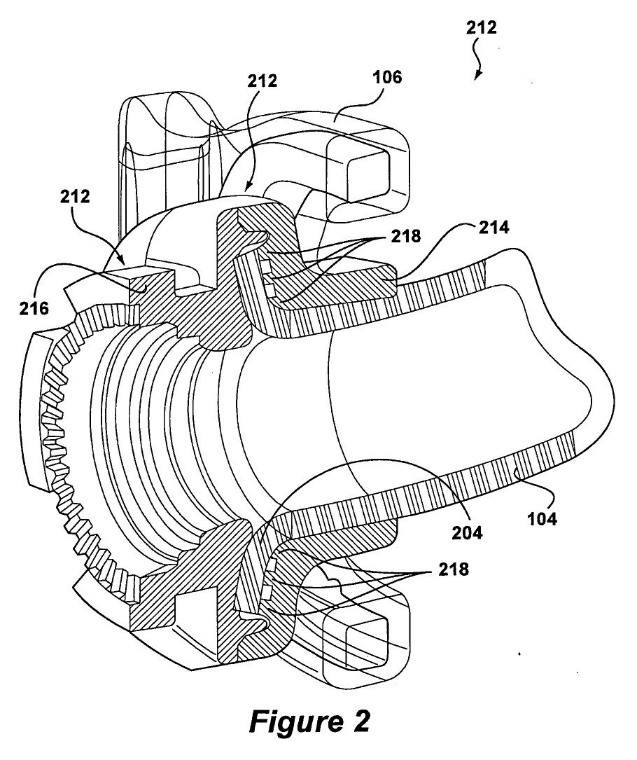

Referring to FIG. 1, depicted is a schematic diagram of a patient ventilation system, according to a specific example embodiment of the present disclosure. A patient 102 has a stoma 114 (opening) leading to his/her trachea 116 in which an outer cannula 104 is inserted. The outer cannula 104 may have a curved portion 105, e.g., L-shaped or substantially L-shaped, so as to follow a contour of the patient's physiology. A neck flange 106 may be attached to the patient's 102 neck, e.g., by tape and/or straps, etc. (not shown). A ventilator hose 108 may couple a ventilator 110 to a hose coupling 118 of a head base connector 212 (FIG. 2).

An inflation collar 112 may be located proximate to the outer wall of the outer cannula 104, and an inflation lumen 120 may be within the wall of the outer cannula 104 or proximate thereto. An air valve port 122 may be used in combination with the inflation lumen 120 and the inflation collar 112 for inflating the inflation collar 112 to create a seal between the inflation collar 112 and the trachea 116 air passage. The inflation collar 112 may also position the outer cannula 104 in the trachea 116. The inflation collar 112 may be inflated with a fluid, e.g., air, nitrogen, saline, water, etc. It should be understood that more than one lumen may be in the wall of the cannula 104 and that the additional lumens therein may be used for various other purposes.

Referring to FIG. 2, depicted is a detailed schematic cutaway view of an exemplary head base connector 212 of the medical device tube, according to a specific example embodiment of the present disclosure. The formed end 204 of the outer cannula 104 may be positioned as shown, e.g., between inner faces of a first portion 216 (e.g., top portion) and a second portion 214 (e.g., bottom portion) of the head base connector 212. The first portion 216 and the second portion 214 may be snapped together and/or they may be held together by, for example but not limited to, adhesive, bonding and/or welding, etc. For example, the first portion 216 and the second portion 214 may be adapted to snap together, with or without subsequently being attached with adhesive, bonded, or welded together. Welding together of the first portion 216 and second portion 214 may be, for example but not limited to, ultrasonic welding. It is contemplated and within the scope of the present disclosure that the portions 216 and 214 may be held together with screws, pins, stakes, filaments, threads, fibers, wires, etc.

The outer cannula 104 may be made by extrusion or injection molding processes using, for example but not limited to, polyvinyl chloride, flexible, rigid or semi-rigid, of a variety of durometers. The formed end 204 may be formed by heating or molding a proximal end of the outer cannula 104. The connector 212 may be fabricated by injection molding using material suited for a desired application.

The inner face of first portion 216 and/or inner face of the second portion 214 may be used to hold the head base connector 212 to the formed end 204 of the outer cannula 104. The inner face(s) of the first portion 216 and/or the second portion 214 may have gripping ridges 218 that may improve the holding strength between the head base connector 212 and the formed end 204 of the outer cannula 104. The formed end 204 may be attached to the inner face(s) of the first portion 216 and/or the second portion 214 by, for example but not limited to, adhesive, bonding and/or welding, etc. This attachment may provide additional holding strength between the head base connector 212 and the outer cannula 104. The second portion 214 may be tapered about where the outer cannula 104 transitions to the formed end 204 so as to relieve stress pressure on the wall of the outer cannula 104.

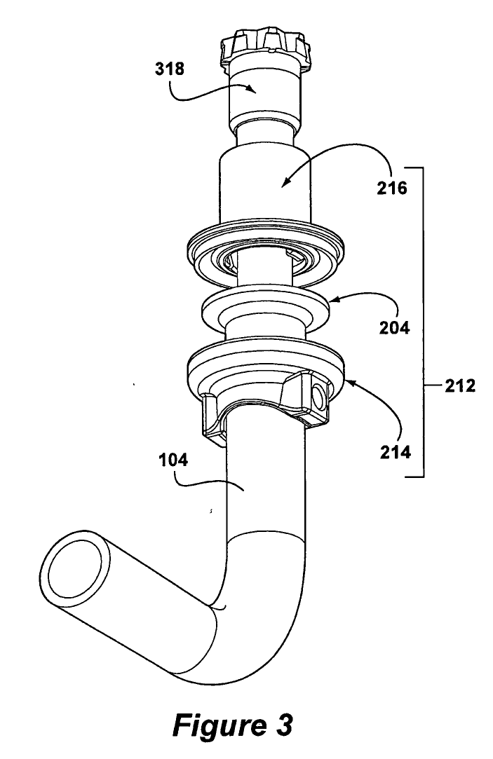

The head base connector 212 may be configured to fit into a neck flange 106, and the head base connector 212 may be configured for coupling to a ventilator hose 108 (FIG. 1). The formed end 204 may be tightly held between the inner faces of the first portion 216 and the second portion 214 so as to maintain the shape (e.g., inner diameter) of the outer cannula 104. This may facilitate easier insertion of an inner cannula assembly 318 (see FIG. 3) into the head base connector 212 and outer cannula 104.

Referring to FIG. 3, depicted is a schematic exploded view diagram of the outer cannula 104 having a formed end 204, first portion 216 and second portion 214 of the head base connector 212, and an inner cannula assembly 318 (assembly shown is truncated for visual clarity) inserted into the head base connector 212 and outer cannula 104, according to a specific example embodiment of the present disclosure.

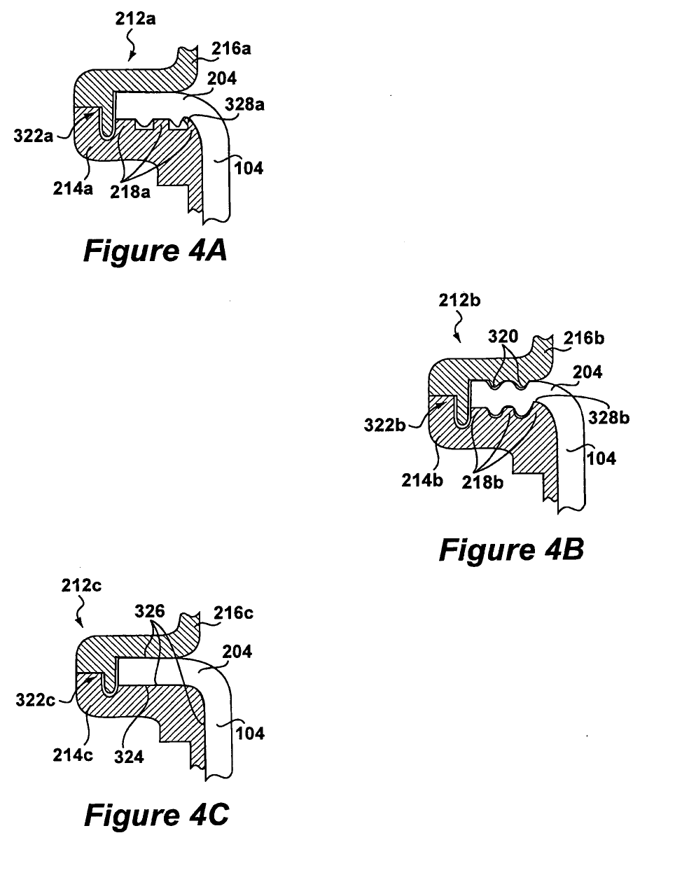

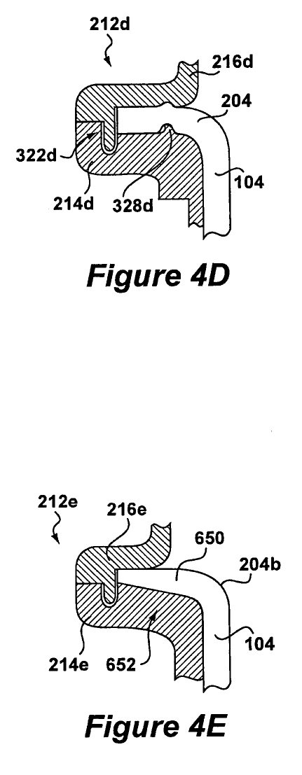

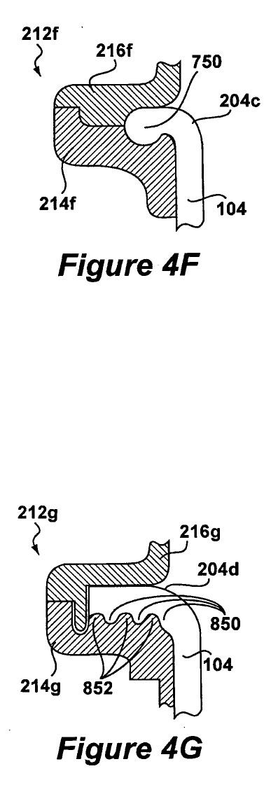

Referring to FIGS. 4A-4D, depicted are schematic cross-sectional diagrams of various exemplary medical device tubes, each having an outer cannula 104 having a formed end 204 held in a head base connector 212. Each illustrated head base connector 212 has a unique inside face surface configuration, according to specific example embodiments of the present disclosure. Generally speaking, a seal may be formed between the inner surface of the formed end 204 and the first portion 216 proximate thereto of the head base connector 212. As discussed above, the first portion 216 and second portion 214 may be held together in an area generally represented by the numeral 322 by, for example but not limited to, adhesive, bonding and/or welding, etc. Welding may be, for example but not limited to, ultrasonic welding. The first portion 216 and second portion 214 may be adapted for snapping together, etc. The first portion 216 and/or the second portion 214 may be integral or comprised of a plurality of parts.

To the extent that adhesive may be used for bonding, locations of possible application of adhesive are generally represented in FIG. 4C by the numeral 326. For example, adhesive may be applied between an inner surface of the first portion 216 and/or second portion 214 and a portion of the outer surface of the outer cannula 104 and/or the formed end 204 for holding together the head base connector 212 and outer cannula 104. Adhesive may also be applied to an outer surface portion of the outer cannula 104 wherein a line normal to the outer surface portion is not perpendicular to the central axis of the outer cannula 104 proximate the surface portion, e.g., an acute angle may be formed or it may be substantially parallel. Adhesive used may be, for example but not limited to, medical grade cyanoacrylate 4161, commercial trade name—LOCTITE® (a registered trademark of the Henkel Corporation, 2200 Renaissance Boulevard, The Triad, Suite 200, 200 Gulph Mills, Pa. 19406).

As depicted in FIG. 4A, ridges 218a may be formed on an inner face of the second portion 214a proximate to the outer surface of the formed end 204. An inner face of the first portion 216a may be substantially smooth and/or textured, and may bias the formed end 204 toward the ridges 218a. Adhesive between the inner face(s) of the first portion 216a and/or the second portion 214a, and the outer surface of the formed end 204 and/or outer cannula 104 may be used to further improve the holding strength therebetween. Barbs 328a may also be used for holding, e.g., gripping, grabbing, biting, etc., the formed end 204 and/or outer cannula 104.

As depicted in FIG. 4B, ridges 218b may be formed on an inner face of the second portion 214b proximate to the formed end 204. An inner face of the first portion 216b may have complementary interposed ridges 320 that may bias the formed end 204 toward the ridges 218b. Adhesive between the inner face(s) of the first 216b and/or second 214b portions and the outer surface of formed end 204 and/or the outer cannula 104 may be used to further improve the holding strength therebetween. The first 216b and second 214b portions may be held together in an area generally represented by the numeral 322b by, for example but not limited to, adhesive, bonding, welding, etc. Barbs 328b may also be used for holding, e.g., gripping, grabbing, biting, etc., the formed end 204 and/or outer cannula 104.

As depicted in FIG. 4C, the inner faces 324 and 326 of the second portion 214c and first portion 216c, respectively, may be proximate to and effectively clamp the formed end 204. Adhesive between the inner faces 324 and 326 and the outer surface of the outer cannula 104 may be added to further improve the holding strength therebetween. The first 216c and second 214c portions may be held together in an area generally represented by the numeral 322c by, for example but not limited to, adhesive, bonding, welding, etc. The surface textures of the inner faces 324 and/or 326 may be smooth, textured, rough, dimpled, grainy; have bumps, barbs or pins thereon; patterns having relief, etc., or any combination thereof, for gripping the surface of the formed end 204.

As depicted in FIG. 4D, barbs 328d may be formed on an inner face of either the first portion 216d and/or the second portion 214d. The barbs 328d may grip the formed end 204 for holding, e.g., gripping, grabbing, biting, etc., the formed end 204 between the first portion 216d and second portion 214d. When the portions 216d and 214d are brought together, another portion opposite to the portion having the barbs 328d may urge the formed end 204 into the barbs 328d. Adhesive between the inner face(s) of the first portion 216d and/or the second portion 214d and the outer surface of the formed end 204 and/or outer cannula 104 may be added to further improve the holding strength therebetween.

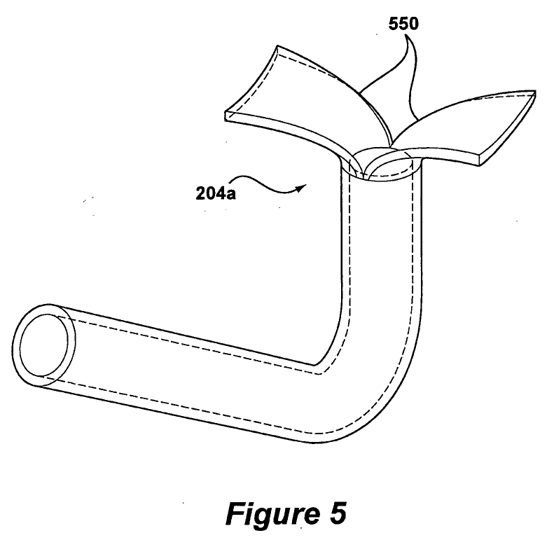

Referring to FIG. 5, depicted is a schematic cutaway view diagram of a medical device tube having a formed end 204a that may be fillet to lay open two or more flats 550 that may be captured by the first and/or second portions of the head base connector (see FIGS. 4A-4D), according to a specific example embodiment of the present disclosure.

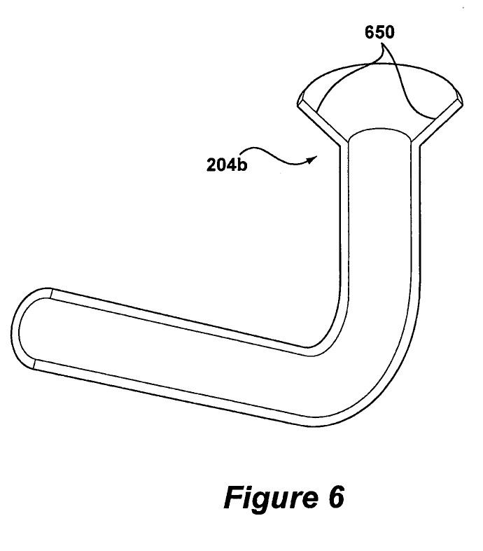

Referring to FIGS. 6 and 4E, depicted are schematic cutaway view diagrams of a medical device tube having a formed end 204b that may be chamfered, represented by the numeral 650, to substantially match a chamfer 652 (see FIG. 4E) on the first and/or second portions 214e and 216e, respectively, of the head base connector 214e, according to a specific example embodiment of the present disclosure.

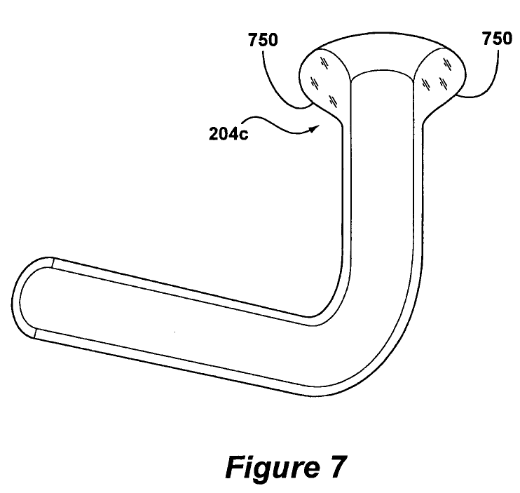

Referring to FIGS. 7 and 4F, depicted are schematic cutaway view diagrams of a medical device tube having a formed end 204c that may be a circumferential bead 750 that may be substantially captured in a corresponding pocket in or on the first and/or second portions 214f and 216f, respectively, of the head base connector (see FIG. 4F), according to a specific example embodiment of the present disclosure.

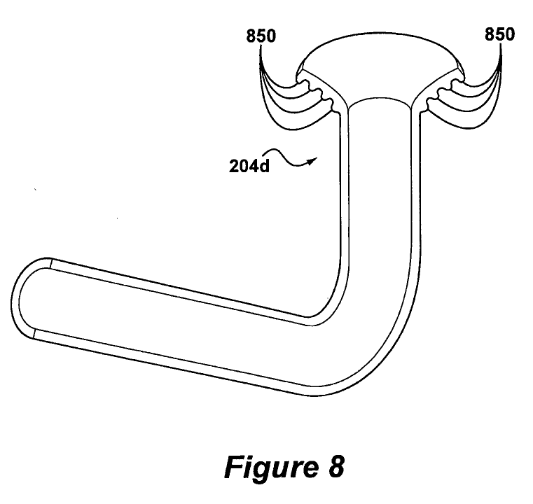

Referring to FIGS. 8 and 4G, depicted are schematic cutaway view diagrams of a medical device tube having a formed end 204d that may have circumferential features 850, e.g., depressions, ridges/valleys, etc., in or on the formed end 204d with these circumferential features 850 adapted to substantially match, e.g., mate, with corresponding retaining features 852, e.g., pockets, radial pockets, etc., in or on the first and/or second portions 214g and 216g, respectively, of the head base connector (see FIG. 4G), according to a specific example embodiment of the present disclosure. For example, these circumferential features 850 may be incorporated during the tube end flaring process. As the tube is reformed, e.g., during a radio frequency flaring process, the tube material may flow into circumferential cut-outs (valleys) resulting in a flared tube with the circumferential features that may mate to the corresponding retaining features 852 in or on the first and/or second portions 214g and 216g, respectively. This may reduce creep of the tube material into (or be forced by) the one portion of the connector (e.g., during ultrasonic welding) the retaining features 850 of the other portion of the connector. Since the circumferential features 850 are already part of the tube and may thus drop into the corresponding retaining features 852.

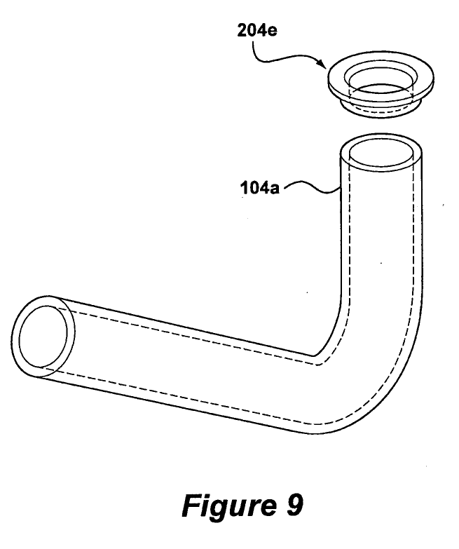

Referring to FIG. 9, depicted is a schematic exploded view diagram of a medical device tube having a separately formed end 204e adapted for attachment to a cannula 104a, according to a specific example embodiment of the present disclosure. The separately formed end 204e that may be attached, e.g., adhesive, welded, etc., to an end of the cannula 104a. The separately formed end 204e attached to the cannula 104a may fit/lock with the first and/or second portions 214 and 216, respectively, of the head base connector.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A medical device tube, comprising:
a cannula having a formed end; and
a connector comprised of a first portion and a second portion, wherein the cannula and the connector are coupled together by the formed end of the cannula being held between the first and second portions of the connector.

2. The medical device tube according to claim 1, wherein the first portion comprises a plurality of first portions.

3. The medical device tube according to claim 1, wherein the second portion comprises a plurality of second portions.

4. The medical device tube according to claim 1, wherein the first and second portions are top and bottom portions, respectively.

5. The medical device tube according to claim 1, wherein the first and second portions are bottom and top portions, respectively.

6. The medical device tube according to claim 1, wherein the formed end comprises a flared end.

7. The medical device tube according to claim 1, wherein the formed end comprises a flute-shaped end.

8. The medical device tube according to claim 1, wherein the formed end comprises a fillet end.

9. The medical device tube according to claim 1, wherein the formed end comprises a chamfered end.

10. The medical device tube according to claim 1, wherein the formed end comprises a circumferential bead end.

11. The medical device tube according to claim 1, wherein the formed end is attached to the cannula.

12. The medical device tube according to claim 1, wherein the formed end comprises circumferential features, wherein the circumferential features comprise at least one of depressions, ridges, or valleys and combinations thereof.

13. The medical device tube according to claim 12, wherein the circumferential features substantially match retaining features of the connector.

14. The medical device tube according to claim 13, wherein the retaining features are integral with the first portion of the connector.

15. The medical device tube according to claim 13, wherein the retaining features are integral with the second portion of the connector.

16. The medical device tube according to claim 13, wherein the retaining features are integral with the first and second portions of the connector.

17. The medical device tube according to claim 1, wherein the formed end of the cannula is in frictional cooperation with the first and second portions of the connector.

18. The medical device tube according to claim 1, wherein the formed end of the cannula is in frictional cooperation with the first portion of the connector.

19. The medical device tube according to claim 1, wherein the formed end of the cannula is held in frictional cooperation with the second portion of the connector.

20. The medical device tube according to claim 1, wherein the first portion of the connector is substantially smooth.

21. The medical device tube according to claim 1, wherein the first portion of the connector is substantially textured.

22. The medical device tube according to claim 1, wherein the second portion of the connector is substantially smooth.

23. The medical device tube according to claim 1, wherein the second portion of the connector is substantially textured.

24. The medical device tube according to claim 1, wherein the first and second portions of the connector are substantially smooth.

25. The medical device tube according to claim 1, wherein the first and second portions of the connector are substantially textured.

26. The medical device tube according to claim 1, comprising at least one groove on the first portion of the connector, wherein the at least one groove grips the formed end of the cannula.

27. The medical device tube according to claim 26, wherein the at least one groove is continuous.

28. The medical device tube according to claim 26, wherein the at least one groove is non-continuous.

29. The medical device tube according to claim 26, wherein the second portion of the connector biases the formed end of the cannula toward the at least one groove of the first portion of the connector.

30. The medical device tube according to claim 1, comprising at least one ridge on the first portion of the connector, wherein the at least one ridge grips the formed end of the cannula.

31. The medical device tube according to claim 30, wherein the at least one ridge is continuous.

32. The medical device tube according to claim 26, wherein the at least one ridge is non-continuous.

33. The medical device tube according to claim 30, wherein the second portion of the connector biases the formed end of the cannula toward the at least one ridge of the first portion of the connector.

34. The medical device tube according to claim 30, wherein the at least one ridge of the first portion of the connector aligns a central axis of the cannula with an axis of the connector.

35. The medical device tube according to claim 1, comprising a plurality of alternating ridges and grooves on the first portion of the connector, wherein the plurality of alternating ridges and grooves holds the formed end of the cannula.

36. The medical device tube according to claim 1, comprising barbs on the first portion of the connector, wherein the barbs hold the formed end of the cannula.

37. The medical device tube according to claim 1, comprising barbs on the second portion of the connector, wherein the barbs hold the formed end of the cannula.

38. The medical device tube according to claim 35, wherein the second portion of the connector biases the formed end of the cannula toward the plurality of alternating ridges and grooves on the first portion of the connector.

39. The medical device tube according to claim 35, wherein the plurality of alternating ridges and grooves on the first portion of the connector form concentric circles thereon.

40. The medical device tube according to claim 1, comprising:
a first plurality of alternating ridges and grooves on the first portion of the connector; and
a second plurality of alternating grooves and ridges on the second portion of the connector that are substantially aligned with the first plurality of alternating ridges and grooves on the first portion of the connector,
wherein the ridges of the first plurality bias the formed end of the cannula toward the grooves of the second plurality and the ridges of the second plurality bias the formed end of the cannula toward the grooves of the first plurality,
thereby gripping the formed end of the cannula .

41. The medical device tube according to claim 1, comprising adhesive between the formed end of the cannula and the first portion of the connector.

42. The medical device tube according to claim 1, comprising adhesive between the formed end of the cannula and the second portion of the connector.

43. The medical device tube according to claim 1, comprising adhesive between the formed end of the cannula and the first and second portions of the connector.

44. The medical device tube according to claim 1, wherein a surface texture of the first portion of the connector proximate to the formed end of the cannula is selected from the group consisting of smooth, textured, rough, dimpled, grainy, bumps, barbs, pins and patterns having relief, and combinations thereof.

45. The medical device tube according to claim 1, wherein a surface texture of the second portion of the connector proximate to the formed end of the cannula is selected from the group consisting of smooth, textured, rough, dimpled, grainy, bumps, barbs, pins and patterns having relief, and combinations thereof.

46. The medical device tube according to claim 1, wherein the first and second portions of the connector snap together.

47. The medical device tube according to claim 1, wherein the first and second portions of the connector are welded together.

48. The medical device tube according to claim 47, wherein the welding is selected from the group consisting of ultrasonic, radio frequency, laser, hot plate and spin welding.

49. The medical device tube according to claim 1, wherein the first and second portions of the connector are bonded together.

50. The medical device tube according to claim 1, wherein the first and second portions of the connector are attached together with adhesive.

51. The medical device tube according to claim 1, wherein the first and second portions of the connector are attached together with screws.

52. The medical device tube according to claim 1, wherein the first and second portions of the connector are screwed together .

53. The medical device tube according to claim 1, wherein the outer cannula and connector are adapted to receive an inner cannula.

54. The medical device tube according to claim 53, wherein the inner cannula is disposable.

55. The medical device tube according to claim 53, wherein the inner cannula is reusable.

56. The medical device tube according to claim 1, wherein the connector is adapted for coupling to a ventilator hose.

57. The medical device tube according to claim 1, wherein the connector is adapted for coupling to a speaking valve.

58. The medical device tube according to claim 1, wherein the connector is adapted for coupling to a resuscitator bag.

59. The medical device tube according to claim 1, wherein the connector is adapted for coupling to a neck flange, wherein the neck flange is secured to a neck of a patient.

60. A tracheostomy air passage system, said system comprising:
a tracheostomy tube comprising,
a cannula having a formed end;
a connector comprising a first portion and a second portion,
wherein the formed end of the cannula is held between the first and second portions of the connector;
a ventilator hose coupled to the connector; and
a ventilator coupled to the ventilator hose.

61. The system according to claim 60, wherein the formed end of the cannula is held in frictional cooperation with the first and second portions of the connector.

62. The system according to claim 60, wherein the formed end of the cannula is attached to the first portion of the connector with adhesive.

63. The system according to claim 60, wherein the formed end of the cannula is attached to the second portion of the connector with adhesive.

64. The system according to claim 60, wherein the formed end of the cannula is bonded to the first portion of the connector.

65. The system according to claim 60, wherein the formed end of the cannula is bonded to the second portion of the connector.

66. The system according to claim 60, wherein the cannula and connector are adapted for insertion of an inner cannula.

67. The system according to claim 66, wherein the inner cannula is disposable.

68. The system according to claim 66, wherein the inner cannula is reusable.
